(19) United States
(12) Patent Application Publication
(10) Pub. No.: US 2013/0062121 A1
(43) Pub. Date: Mar. 14, 2013

(54) ELECTRONIC UNIT

(71) Applicant: Tomoyuki Yoshimatsu, Tokyo (JP)

(72) Inventor: Tomoyuki Yoshimatsu, Tokyo (JP)

(73) Assignee: SONY CORPORATION, Tokyo (JP)

(21) Appl. No.: 13/597,683

(22) Filed: Aug. 29, 2012

(30) Foreign Application Priority Data
Sep. 8, 2011 (JP) 2011-196402

(51) Int. Cl. H01R 4/28

(52) U.S. Cl. 174/94 S

(57) ABSTRACT

An electronic unit includes: a plate-shaped support member having an insulating surface and a conductive surface that are opposed to each other; a cut-and-raised section provided in the support member, and having a contact that is bent to protrude toward the conductive surface, and a pair of through holes provided at side faces of the cut-and-raised section; and a substrate inserted into the pair of through holes, and with which the contact is in elastic and electric contact.

### BACKGROUND

The disclosure relates to an electronic unit having a substrate with an element such as a circuit, the substrate being provided on a conductive support member having an insulating film on one surface, such as a back chasses.

All kinds of electronic units generate electromagnetic waves (radio waves) while performing their operation. Examples of the electronic units include information-processing equipment such as Personal Computers (PCs) and portable telephones, household appliances such as TVs, and automatic machine tools used in factories. The radio waves emitted from portable telephones, TVs, and the like, for example, are necessary for information transmission, and utilized effectively. On the other hand, the radio waves emitted from PCs are unnecessary, and appear, for example, as a noise in a screen or sound of a TV. Such an interference caused by the unnecessary radio waves (unnecessary radiation) emitted from the electronic units is called Electromagnetic Interference (EMI).

For example, in a display such as a TV, the following has been taken as a measure against EMI. For instance, a substrate provided with a printed circuit is connected to a metallic component (such as a back chassis) serving as a ground, and thereby an electric potential is stabilized. This suppresses generation of a noise due to unnecessary radiation from the printed circuit.

However, there is a case where the back chassis is covered by, for example, an insulating coating or the like based on a design specification, because otherwise the back chassis is bare all the time while serving as a part of an external housing depending on its structure. In this case, it is difficult to establish electrical continuity by only laying the substrate on the back chassis, which makes the measure against EMI insufficient.

In order to address this situation, Japanese Unexamined Patent Application Publication No. H06-350269, for example, discloses an electronic unit in which a substrate and a back chassis are secured by screws, and electrical continuity between the substrate and the back chassis is ensured through these screws.

### SUMMARY

In the method disclosed in Japanese Unexamined Patent Application Publication No. H06-350269, the substrate and a conductive surface of the back chassis are not in direct contact with one another, and the electrical continuity is established through the screws. Therefore, there is still room for further improvement in terms of ensuring sufficient electrical continuity.

It is desirable to provide an electronic unit capable of ensuring electrical continuity between a substrate and a metallic component.

According to an embodiment of the technology, there is provided an electronic unit including: a plate-shaped support member having an insulating surface and a conductive surface that are opposed to each other; a cut-and-raised section provided in the support member, and having a contact that is bent to protrude toward the conductive surface, and a pair of through holes provided at side faces of the cut-and-raised section; and a substrate inserted into the pair of through holes, and with which the contact is in elastic and electric contact.

In the electronic unit according to the above-described embodiment of the technology, the substrate and the conductive surface of the support member are brought into direct electric contact with each other through the contact that is bent to protrude toward the conductive surface side, by inserting the substrate into the through holes of the cut-and-raised section. As used herein, the wording “bent to protrude” includes and refers to, for example but not limited to, a letter-M-like shape, an arch-like shape, a trapezoid-like shape, and any other suitable shape that allows the substrate and the conductive surface of the support member to be in the elastic and electric contact with each other.

According to the electronic unit in the above-described embodiment of the technology, the cut-and-raised section is provided in the support member. In this cut-and-raised section, the contact that is bent to protrude toward the conductive surface is provided, and the pair of through holes into which the substrate is to be inserted are provided at the side faces. Thus, the substrate and the conductive surface of the support member are allowed to be in direct contact with each other through the contact. Therefore, electrical continuity between the substrate and the conductive surface of the support member is ensured more reliably.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIGS. 1A and 1B are cross-sectional diagrams each illustrating an electrical contact section between a substrate and a support member of an electronic unit according to an embodiment of the disclosure.

FIGS. 2A and 2B are schematic diagrams each illustrating a shape of a cut-and-raised section of the support member depicted in FIGS. 1A and 1B.

FIG. 3 is a diagram illustrating a cross-sectional configuration of a display taken as an example of the electronic unit according to the embodiment of the disclosure.

FIG. 4 is a plan view illustrating a configuration including the substrate and the support member of the display depicted in FIG. 3.

FIG. 5 is a cross-sectional diagram illustrating a connection section between a substrate and a support member according to a comparative example 1.

FIG. 6 is a cross-sectional diagram illustrating a connection section between a substrate and a support member according to a comparative example 2.

FIG. 7 is a cross-sectional diagram illustrating the electrical contact section according to a modification 1 of the disclosure.

FIG. 8 is a cross-sectional diagram illustrating the electrical contact section according to a modification 2 of the disclosure.

FIG. 9 is a cross-sectional diagram illustrating the electrical contact section according to a modification 3 of the disclosure.

FIG. 10 is a cross-sectional diagram illustrating the electrical contact section according to a modification 4 of the disclosure.

FIG. 11 is a plan view illustrating a schematic configuration of a module to which the electrical contact section is applied.

FIGS. 12A and 12B are perspective diagrams of an application example 1, namely, FIG. 12A illustrates an appearance when viewed from front, and FIG. 12B illustrates an appearance when viewed from back.

FIG. 13 is a perspective diagram illustrating an appearance of an application example 2.

FIG. 14 is a perspective diagram illustrating an appearance of an application example 3.

FIGS. 15A to 15G are diagrams of an application example 4, namely, a front view in an open state, a side view in the open state, a front view in a closed state, a left-side view, a right-side view, a top view, and a bottom view, respectively.

### DETAILED DESCRIPTION

An embodiment of the disclosure will be described below in detail with reference to the drawings. It is to be noted that the description will be provided in the following order.

1. Embodiment (a cut-and-raised section shaped like a letter M)
1-1. Configuration of cut-and-raised section
1-2. Configuration of display

2. Modification 1 (a cut-and-raised section having an arch shape)

3. Modification 2 (a cut-and-raised section having a trapezoid shape)

4. Modification 3 (a cut-and-raised section having a break part)

5. Modification 4 (a cut-and-raised section having a plurality of electrical contact sections)

6. Application examples 1 to 5

### 1. Embodiment

### (1-1. Configuration of Cut-and-Raised Section)

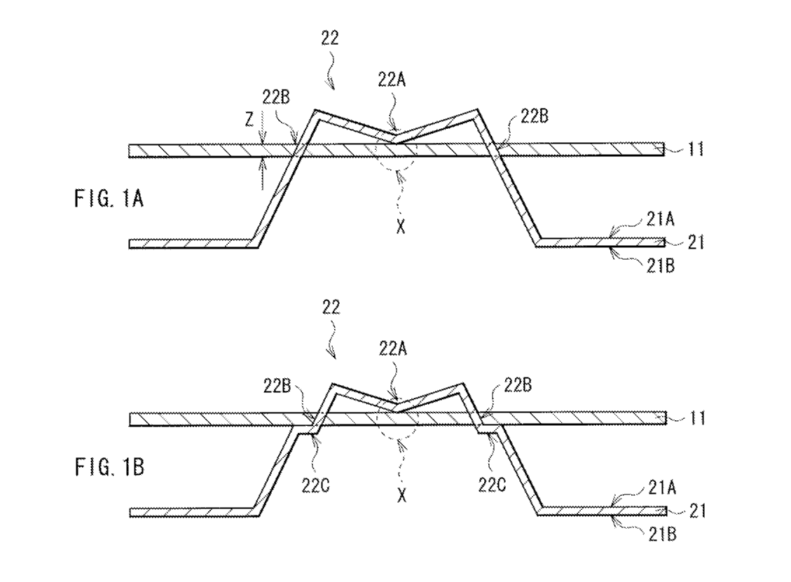

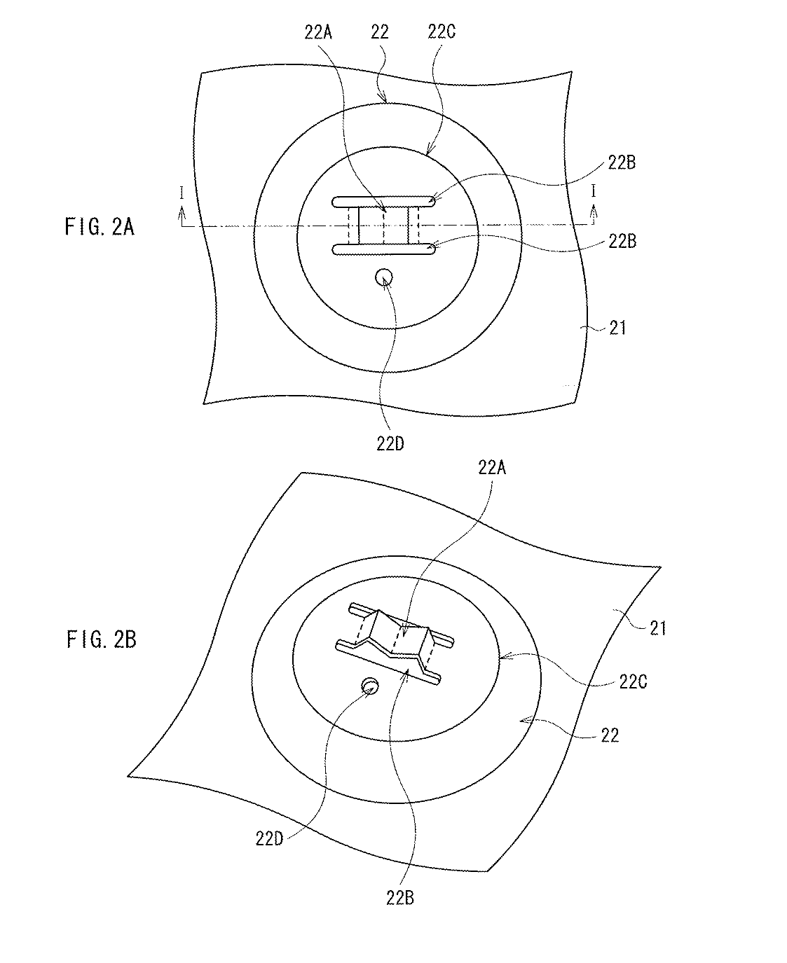

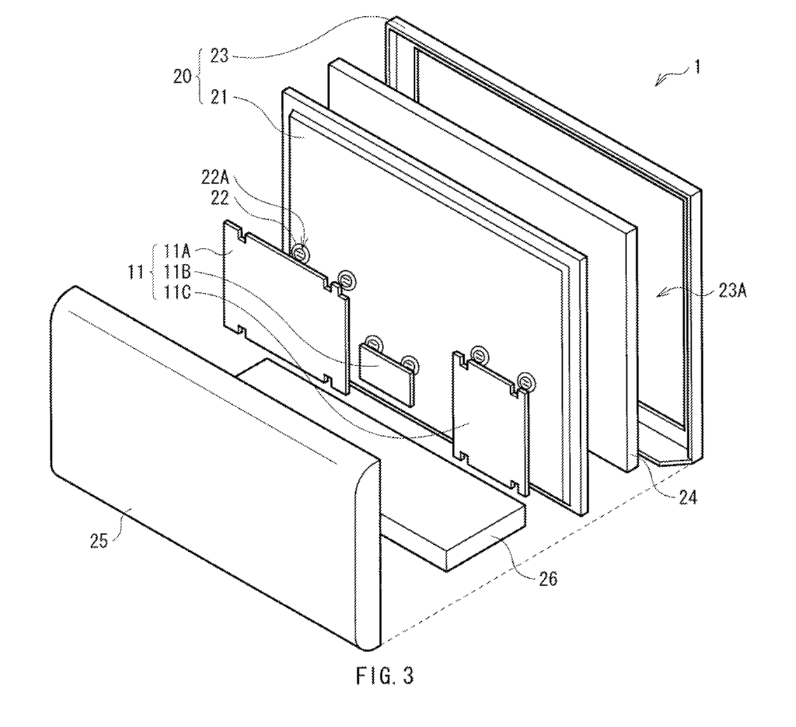

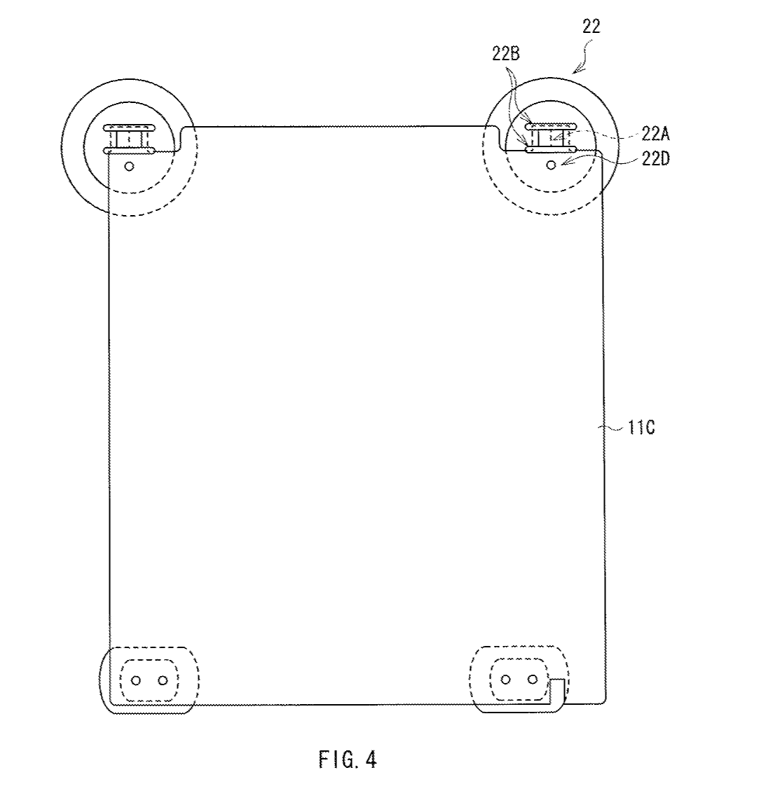

FIGS. 1A and 1B each illustrate a cross-sectional configuration of an electrical contact section X between a substrate 11 and a cut-and-raised section 22 of a support member 21, in an electronic unit (such as a display 1; see FIG. 3 and FIG. 4) according to an embodiment of the disclosure. FIG. 2A illustrates a plane configuration of the cut-and-raised section 22 illustrated in FIG. 1B, and FIG. 2B is a perspective diagram of the cut-and-raised section 22. FIGS. 1A and 1B each illustrate a cross section of the cut-and-raised section 22 taken along a dashed line I-I illustrated in FIG. 2A, and the substrate 11. The support member 21 is a conductive plate-shaped member (such as a metal plate), and has an insulating surface 21A on one side and a conductive surface 21B on the other side. An insulating film (not illustrated) is formed on the insulating surface 21A. The cut-and-raised section 22 is formed to protrude on the insulating surface 21A side.

In the present embodiment, a depression section 22A bent to protrude toward the conductive surface 21B side is formed in the cut-and-raised section 22. Specifically, the depression section 22A is processed to be M-shaped, as illustrated in FIGS. 1A and 1B, for example. Further, a pair of through holes 22B are formed on the respective side faces of this cut-and-raised section 22, and the substrate 11 is attached to the support member 21 by being inserted into these through holes 22B. The depth of the depression section 22A provided in the cut-and-raised section 22, and the position of each of the through holes 22B formed in the side faces of the cut-and-raised section 22 are adjusted as appropriate, depending on a space between the substrate 11 and the support member 21 when arranged, as well as the thickness of the substrate 11. Specifically, for example, a distance Z between the bottom of the through holes 22B and the underside of the depression section 22A is set as the thickness of the substrate 11, and thereby the substrate 11 and the depression section 22A of the support member 21 contact each another. This makes it possible to form the contact section X (a contact), which is elastic and electrical, between the substrate 11 and the conductive surface 21B of the support member 21. It is more preferable that the distance Z be less than the thickness of the substrate 11, so that the contact section X between the substrate 11 and the conductive surface 21B of the support member 21 is reliably formed by press-fitting the substrate 11 into the cut-and-raised section 22 of the support member 21. Moreover, since securing the substrate 11 to the support member 21 is also enabled, fixing with a screw is unnecessary. It is to be noted that the cut-and-raised section 22 is provided with a step 22C as illustrated in FIG. 1B. Specifically, a flat surface (the step 22C), which is different from a flat surface formed at the support member 21, is provided at the cut-and-raised section protruding on the insulating surface 21A side. Formation of the depression section 22A and the through holes 22B in agreement with this step 22C allows the substrate 11 to be supported more stably.

### (1-2. Configuration of Display)

FIG. 3 is an exploded perspective diagram illustrating an overall configuration of the display 1 having the electrical contact section X between the substrate 11 and the support member 21. For example, the display 1 may be a liquid crystal display used as a television receiver. In this display 1, a display panel 24 including elements such as an optical sheet, a light-guiding plate, and a light source (none of them illustrated) is housed in a housing 20 including a front bezel 23 and a back chassis 21 (the support member). The substrate 11, which has elements such as a circuit that controls driving of the display panel 24, is disposed on a back face of the back chassis 21. The substrate 11 is covered by a rear cover 25. The cut-and-raised section 22, the depression section 22A, and the like, for example, are formed in the back chassis 21. Thus, the substrate 11 disposed on the back face of the back chassis 21 and the conductive surface 21B of the back chassis 21 are electrically connected to each other, and also, the substrate 11 is fixed.

The housing 20 is, for example, substantially shaped like a rectangular solid. The housing 20 has two opposed surfaces, namely, a display surface and a back face, and also has side faces between these two surfaces. The housing 20 includes the front bezel 23 and the back chassis 21. The front bezel 23 covers a front face and side faces of the display panel 24, the side faces being provided between the front face and a back face of the display panel 24. The back chassis 21 covers the back face of the display panel 24.

The front bezel 23 is a frame provided in front of the display panel 24 and used to fix the display panel 24 as described above. The front bezel 23 has an opening 23A, and this opening 23A allows an image displayed on the display panel 24 to be viewed. As a material of the front bezel 23, for example, a metal having a high thermal conductivity such as aluminum (Al) is used. Besides this, for example, iron (Fe), polycarbonate (PC), plastic in which ABS resin is added to the polycarbonate, or the like can be used. It is to be noted that when the front bezel 23 is configured using a metallic material, the faces exposed outside (here, the front face and the side faces) may be covered by an insulating film (not illustrated).

As described above, the back chassis 21 covers at least the back face of the display panel 24, and is used to fix the display panel 24 as well as the substrate 11. The substrate 11 is provided with elements such as a control circuit that controls driving of the display panel 24. As with the front bezel 23, a metal having a high thermal conductivity such as Al is used as a material of the back chassis 21, for example. Also, the surface (here, the back face) exposed outside may be covered by an insulating film (not illustrated), as in the front bezel 23. As a specific material of the back chassis 21, besides Al, Fe or other suitable material having a high thermal conductivity may be used. In the back chassis 21, for example, there are formed the cut-and-raised section 22, the depression section 22A, and the like used to bring the substrate 11 and the conductive surface of the back chassis 21 into contact with each other, as described above. The cut-and-raised section 22, the depression section 22A, and the like are formed at each of a plurality of optional positions where the substrate 11 is to be disposed. FIG. 4 schematically illustrates the back chassis 21 and a substrate 11C disposed on the back face of the back chassis 21. The cut-and-raised section 22 is provided with the step 22C as illustrated in FIG. 1B. It is to be noted that, here, a through hole 22D used for screw-fixing is formed in proximity to the cut-and-raised section 22, specifically, within the flat surface on the step 22C. Here, the substrate 11 is secured by the screw-fixing. However, as mentioned above, the screw-fixing may be omitted by designing the distance Z between the bottom of the through holes 22B and the underside of the depression section 22A so that the distance Z is less than the thickness of the substrate to be inserted. In addition, here, holes for screw-fixing are separately provided at a side (a lower side) facing one side (an upper side) where the electrical contact section X between the substrate 11 and the back chassis 21 is formed, and the substrate 11 is fixed to the back chassis 21 by screws.

The display panel 24 is provided to display images such as a moving image and a still image. The display panel 24 is, for example, a liquid-crystal display panel having a liquid crystal layer between two substrates, namely a TFT substrate and a CF substrate. On each of the TFT substrate and a surface of the CF substrate, which is opposite to a surface where the liquid crystal layer is provided (i.e. on each of the front face (the display surface) and the back face), there is provided a polarizing plate that allows polarized light in a specific direction to pass therethrough. In addition, the light-guiding plate is provided on a back face of the TFT substrate. On one end surface of the light-guiding plate, a plurality of LEDs, for example, are disposed as the light source. Light emitted from this light source is incident upon the liquid crystal layer through the light-guiding plate, and extracted as display light on the front bezel 23 side.

In the TFT substrate, for example, a plurality of pixel electrodes (not illustrated) are arranged in a matrix on a glass substrate. This TFT substrate is provided with elements such as TFT (Thin Film Transistor) devices and gate lines as well as source lines (none of them illustrated). The TFT devices are provided to drive the plurality of pixel electrodes. The gate lines and the source lines are connected to these TFT devices. Each of the pixel electrodes is formed of, for example, a transparent conductive material such as ITO (Indium Tin Oxide), and provided for every subpixel (not illustrated) on the glass substrate.

The CF substrate has a color filter (not illustrated) provided on the glass substrate and including, for example, stripe-shaped filters of red (R), green (G), and blue (B). The CF substrate also has a counter electrode (not illustrated) almost over the entire surface of an effective display region S2 on this color filter. The counter electrode is configured using, for example, a transparent conductive material such as ITO, as with the pixel electrode. It is to be noted that, here, between the counter electrode and the pixel electrodes on the TFT substrate side, a spacer used to keep a gap between both substrates may be provided, although it is not illustrated.

In a case of using a liquid crystal panel of a vertical alignment type, the liquid crystal layer includes, for example, liquid crystal molecules having negative dielectric anisotropy, and a polymer structure maintaining the liquid crystal molecules in proximity to an interface with an alignment film (not illustrated). The liquid crystal molecule has such a property that a dielectric constant in a major-axis direction is greater than that in a minor-axis direction. Because of this property, the liquid crystal molecules are aligned so that a major axis of the liquid crystal molecule is perpendicular to the substrate when a drive voltage is OFF, and are tilted and oriented so that the major axis is parallel with the substrate when the drive voltage is OFF. Thus, an image is displayed on the liquid-crystal display panel.

The optical sheet is provided to perform various kinds of optical functions, for the light emitted from the light source and irradiated upon the liquid crystal layer through the light-guiding plate. As the optical sheet, a single layer or a laminated layer of a sheet may be used. This sheet forming the layer has, for instance, a function of separating the display light emitted from the light source and irradiated upon the liquid crystal layer through the light-guiding plate, into incident light and light with a polarized component orthogonal to the incident light. The sheet may have, for example, a function of achieving a wide viewing angle and preventing coloring, by compensating a phase difference between light waves, or a function of scattering the display light.

The light-guiding plate propagates the light entering from the light source to guide the light to the liquid crystal layer. The light-guiding plate is, for example, in a shape of a rectangular flat plate. For the light-guiding plate, a material having high transparency such as glass may be used, but other materials may be used as long as these other materials are capable of propagating the light from the light source. For example, the light-guiding plate may be formed of a light scattering material in which light-scattering fine particles are dispersed, or a light diffusion material. Specifically, for examples, acrylic resin, polymethyl methacrylate (PMMA), polycarbonate (PC), cyclic polyolefin (COP), and the like may be used. The shape, size, refractive index, density, concentration distribution, and the like, for instance, of the light-guiding plate may be adjusted optionally to achieve desired properties.

As the light source, for example, besides a white LED (Light-Emitting Diode), LEDs emitting color light such as red, blue, and green may be used. Further, other than a point light source such as the LED, a line light source such as fluorescent light may be used. The light source may be provided at the one end surface (an undersurface) of the light-guiding plate as described above, but is not limited thereto and may be disposed along four sides of the light-guiding plate.

As illustrated in FIG. 3, the display 1 is completed by housing the display panel 24 in the housing 20 configured of the front bezel 23 and the back chassis 21, and placing the housing 20 at a stand 26 provided with elements such as a speaker. The stand 26 may have, for example, a stationary-type paper-weight structure in the shape of a rectangular flat plate, but is not limited thereto. Alternatively, there may be adopted a tilt-swivel mechanism capable of changing the direction of a screen of the display panel 24 upwards, downwards, leftwards, and rightwards.

In the display 1, after passing through the polarizing plate via the light-guiding plate and the optical sheet, the light emitted from the light source passes through the liquid crystal layer while being modulated for every pixel based on an image voltage applied between the respective transparent electrodes of the TFT substrate and the CF substrate. After passing through the liquid crystal layer, the light passes through the color filter and then is extracted as color display light to outside (the surface side) of the polarizing plate.

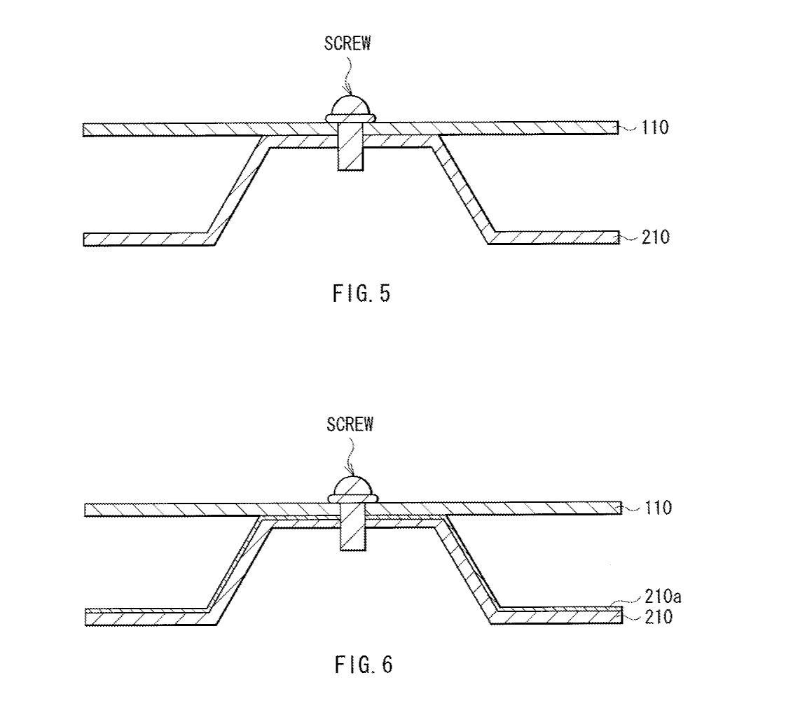

FIG. 5 and FIG. 6 each illustrate a cross section of a connection section between a substrate 110 and a support member 210 (a back chassis) according to a comparative example. In FIG. 5, a metal plate with a surface (in particular, a surface to be joined to the substrate 110) subjected to no treatment is used as the support member 210, and this metal plate and the substrate 110 are secured to each other with a screw. This metal plate and the substrate 110 are in direct contact with each other, and thus electrically well connected to each other. However, as mentioned earlier, this metal plate is exposed outside as a part of a housing such as a back chasses in an electronic unit (e.g., the display 1), and therefore, an insulating layer is formed on a surface of the metal plate. In FIG. 6, the support member 210 having an insulating film 210a and the substrate 110 are secured to each other with a screw. The insulating film 210a is formed on the side where there is the surface to be jointed to the substrate 110. In this case, a conductive surface of the metal plate and the substrate 110 are not in direct contact with each other, and electrical continuity is established only through the screw that secures them. However, there is a possibility that sufficient electrical continuity between the metal plate and the substrate 110 will not be achieved by only thus providing the electrical continuity through the screw.

In the present embodiment, in contrast, the cut-and-raised section 22 is provided in the support member 21 in which the insulating film is formed on the side where the substrate 11 is disposed. In addition, the pair of through holes 22B provided to insert the substrate 11 into the side faces of the cut-and-raised section 22 are formed. Further, the depression section 22A bent to protrude toward the conductive surface side is provided in the cut-and-raised section 22, thereby allowing the substrate 11 and the conductive surface of the support member 21 to be in direct contact with each other elastically and electrically.

As described above, in the electronic unit of the present embodiment, the cut-and-raised section 22 is provided in the support member 21 having the insulating film on the side where the substrate 11 mounted with the elements such as a control circuit is provided. Further, the through holes 22B are formed to insert the substrate 11 into the side faces of the cut-and-raised section 22. Furthermore, the depression section 22A bent to protrude toward the conductive surface side is formed in the cut-and-raised section 22. This brings the substrate 11 and the conductive surface of the support member 21 into direct contact with each other by inserting the substrate 11 into the through holes 22B, without using other component. In other words, electrical continuity between the substrate 11 and the support member 21 are ensured with reliability.

In addition, the substrate 11 is allowed to be fixed to the support member 21, by adjusting the depth of the depression section 22A, namely, the distance Z between the bottom of the through holes 22B and the underside of the depression section 22A, without using any screw. Therefore, the number of components is allowed to be reduced, which enables a reduction in cost.

Modifications 1 to 4 will be described below. It is to be noted that the same elements as those of the embodiment described above will be provided with the same characters as those of the embodiment, and the description thereof will be omitted.

### 2. Modification 1

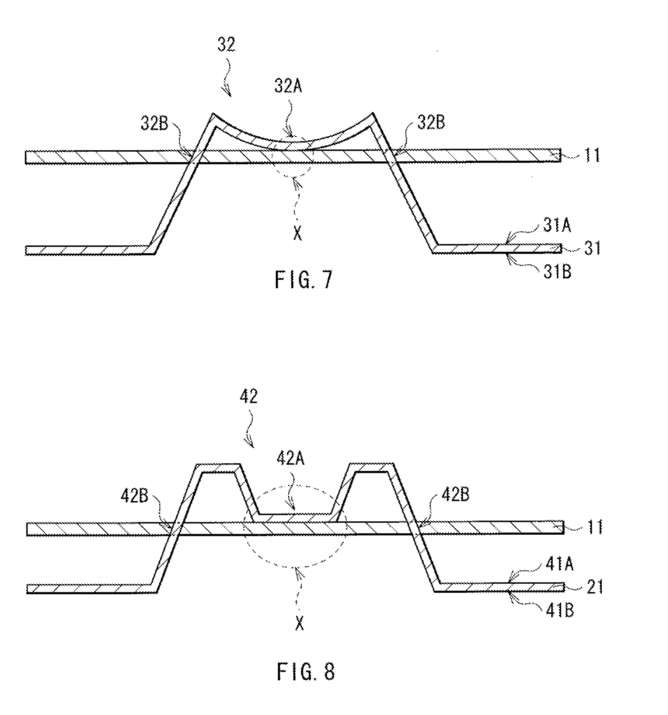

FIG. 7 illustrates a cross-sectional configuration of the electrical contact section X between the substrate 11 and a cut-and-raised section 32 according to the electronic unit in the modification 1 of the disclosure. The cut-and-raised section 32 is provided in a support member 31 having an insulating surface 31A and a conductive surface 31B. The cut-and-raised section 32 of the present modification differs from the cut-and-raised section 22 according to the embodiment described above, in that a depression section 32A is bent like an arch to protrude toward the conductive surface 31B side. In this way, the electrical contact section X between the substrate 11 and the support member 31 may be formed to be bent in the shape of an arch protruding toward the conductive surface 31B side, without being limited to the shape of an M in the embodiment described above.

### 3. Modification 2

FIG. 8 illustrates a cross-sectional configuration of the electrical contact section X between the substrate 11 and a cut-and-raised section 42 according to the electronic unit in the modification 2 of the disclosure. The cut-and-raised section 42 is provided in a support member 41 having an insulating surface 41A and a conductive surface 41B. As illustrated in FIG. 8, the cut-and-raised section 42 of the present modification differs from the cut-and-raised section according to the embodiment described above, in that a depression section 42A that is bent to protrude toward the conductive surface 41B is shaped like a trapezoid, specifically, the depression section 42A has a bottom face. Providing a flat surface at the bottom of the depression section 42A in this way allows surface contact between the substrate 11 and the conductive surface of the support member 41.

In this way, the surface contact is achieved by forming the depression section 42A of the cut-and-raised section 42 to be in the shape of a trapezoid. This allows an increase in contact area of the electrical contact section X between the substrate 11 and the support member 41. Consequently, contact resistance between the substrate 11 and the support member 41 is reduced.

### 4. Modification 3

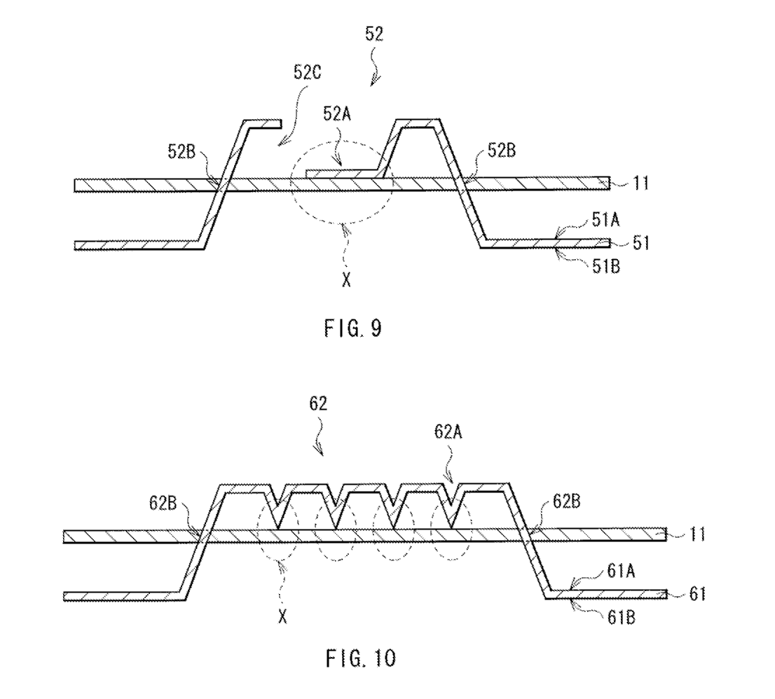

FIG. 9 illustrates a cross-sectional configuration of the electrical contact section X between the substrate 11 and a cut-and-raised section 52 according to the electronic unit in the modification 3 of the disclosure. The cut-and-raised section 52 is provided in a support member 51 having an insulating surface 51A and a conductive surface 51B. This cut-and-raised section 52 has a depression section 52A shaped like a trapezoid, as in the modification 2. The present modification differs from the embodiment and the modifications 1 and 2 described above, in that a cantilever structure is provided in which one of slopes forming this depression section 52A is cut to form a break part 52C.

In the present modification, since the cantilever structure is employed in which the break part 52C is provided at the depression section 52A of the cut-and-raised section 52, elasticity of the depression section 52A increases. This allows the substrate 11 to be fixed further stably and reliably, when the substrate 11 is inserted into the through holes 52B. In addition, the present modification is adaptable to a change in the thickness of the substrate 11. Therefore, it is not necessary to appropriately adjust the distance between the bottom of the through holes 52B and the underside of the depression section 52A depending on the thickness of the substrate 11 as described in the above embodiment.

### 5. Modification 4

FIG. 10 illustrates a cross-sectional configuration of the electrical contact section X between the substrate 11 and a cut-and-raised section 62 according to the electronic unit in the modification 4 of the disclosure. The cut-and-raised section 62 is provided in a support member 61 having an insulating surface 61A and a conductive surface 61B. The cut-and-raised section 62 of the present modification differs from the cut-and-raised section according to each of the embodiment and the modifications 1 to 3 described above, in that a plurality of depression sections 62A are provided. It is to be noted that, here, each of the depression sections 62A is M-shaped as in the embodiment described above, but is not limited thereto, and may be shaped like an arch or a trapezoid as in the modifications 1 and 2.

In the present modification, since the plurality of depression sections 62A of the cut-and-raised section 62 are provided, the contact area increases more than that in one point contact in the embodiment and the modification 1. The present modification is also adaptable to variations in manufacturing.

The technology has been described with reference to the example embodiment and the modifications 1 to 4, but is not limited thereto and may be variously modified. For example, although the liquid crystal display has been taken as an example of the display 1 in the embodiment described above, the housing 20 may be applied to, for instance, a display such as a plasma display and an organic electroluminescence display.

In each of the example embodiment and the modifications, there is provided the electrical contact section X between the substrate and the cut-and-raised section provided in the support member that has the insulating surface and the conductive surface. This electrical contact section X may be used in an electronic unit in any of application examples 1 to 4 which will be described below, for example.

### Module and Application Examples

Now, there will be described application examples of the electrical contact section X between the substrate and the conductive surface of the support member according to each of the embodiment and the modifications. The display 1 according to each of the embodiment and the modifications is applicable to electronic units in all fields, which display externally-input image signals or internally-generated image signals as still or moving images. The electronic units include, for example but not limited to, digital cameras, laptop computers, portable terminals such as portable telephones, video cameras, and the like, in addition to television receivers such as the one illustrated in FIG. 3.

### (Module)

For instance, the electrical contact section X between the substrate and the conductive surface of the support member in each of the embodiment and the modifications is incorporated, as a module illustrated in FIG. 11, into any of various kinds of electronic units such as the application examples 1 to 4 which will be described below. This module is formed, for example, by providing a region 210 exposed at one side of the substrate 11 from a protective film 20 and a sealing substrate 30. In this exposed region 210, an external connection terminal (not illustrated) is formed by extending wires of a signal-line driving circuit and a scanning-line driving circuit. This external connection terminal may be provided with a flexible printed circuit (FPC) 220 for input and output of signals.

### Application Example 1

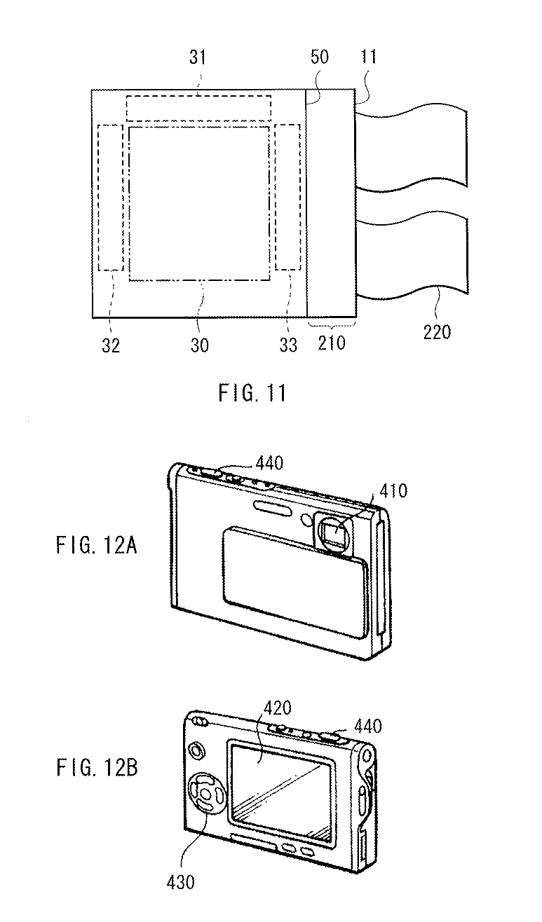

FIGS. 12A and 12B are external views of a digital camera to which the electrical contact section X between the substrate and the conductive surface of the support member according to any one of the embodiment and the modifications is applied. This digital camera includes, for example, a flash emitting section 410, a display section 420, a menu switch 430, and a shutter release 440. The display section 420 is configured using the display 1 according to any one of the embodiment and the modifications described above.

### Application Example 2

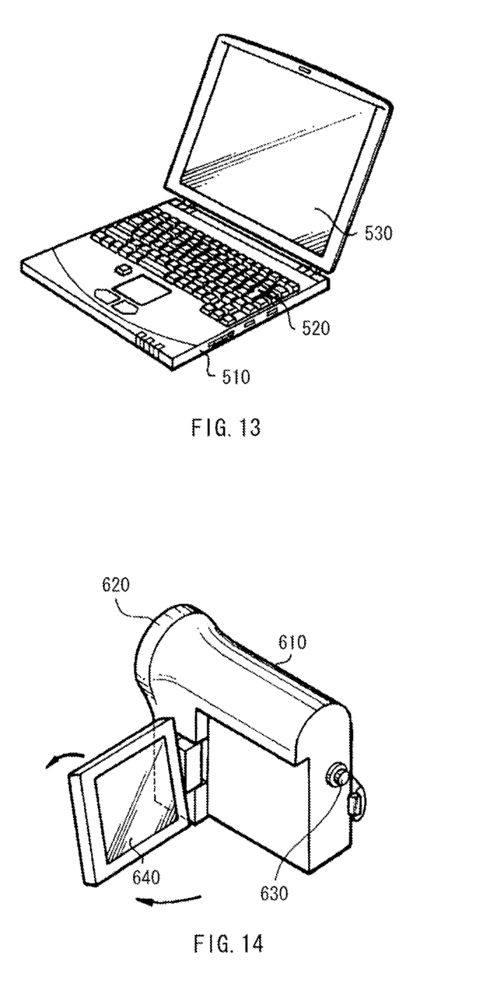

FIG. 13 is an external view of a laptop computer to which the electrical contact section X between the substrate and the conductive surface of the support member according to any one of the embodiment and the modifications is applied. This laptop computer includes, for example, a main body section 510, a keyboard 520 used to enter characters and the like, and a display section 530 displaying an image. The display section 530 is configured using the display 1 according to any one of the embodiment and the modifications described above.

### Application Example 3

FIG. 14 is an external view of a video camera to which the electrical contact section X between the substrate and the conductive surface of the support member according to any one of the embodiment and the modifications is applied. This video camera includes, for example, a main body section 610, a lens 620 disposed on a front face of this main body section 610 to shoot an image of a subject, a start/stop switch 630 used in shooting, and a display section 640. The display section 640 is configured using the display 1 according to any one of the embodiment and the modifications described above.

### Application Example 4

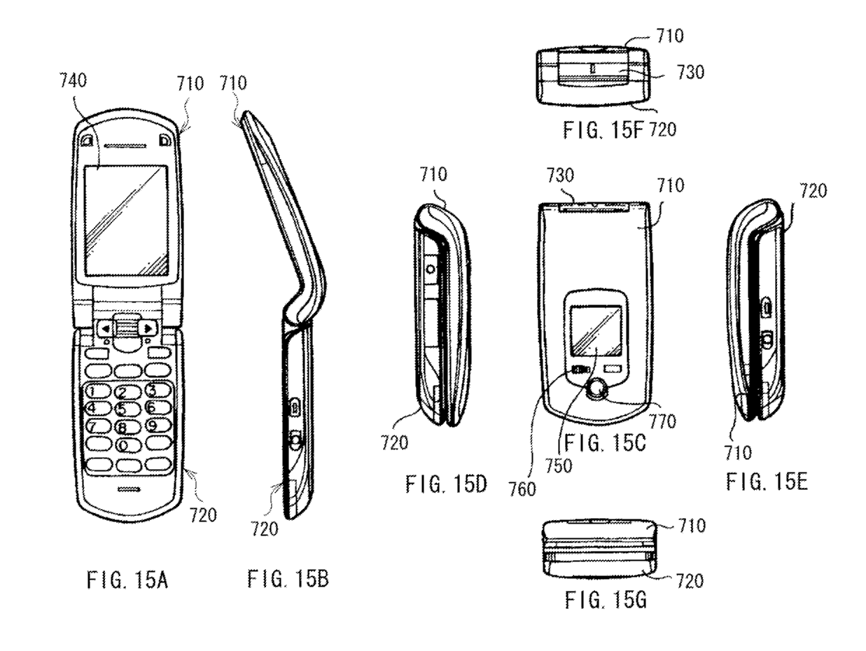

FIGS. 15A to 15G are external views of a portable telephone to which the electrical contact section X between the substrate and the conductive surface of the support member according to any one of the embodiment and the modifications is applied. This portable telephone is, for example, a unit in which an upper housing 710 and a lower housing 720 are connected by a coupling section (a hinge section) 730, and includes a display 740, a sub-display 750, a picture light 760, and a camera 770. The display 740 or the sub-display 750 is configured using the display 1 according to any one of the embodiment and the modifications described above.

The technology has been described with reference to the example embodiment, the modifications 1 to 4, and the application examples 1 to 4, but is not limited thereto and may be variously modified. For example, the display has been described as an example in each of the embodiment, the modifications, and the application examples. However, the technology is applicable to various kinds of electronic units such as, but not limited to, players and recorders for BD (Blu-ray Disc) and DVD (Digital Versatile Disc), and game consoles.

As used herein, the term “plate” may be used interchangeably with the term “sheet”.

Accordingly, it is possible to achieve at least the following configurations from the above-described example embodiments, the modifications, and the application examples of the disclosure.

(1) An electronic unit, including:

a plate-shaped support member having an insulating surface and a conductive surface that are opposed to each other;

a cut-and-raised section provided in the support member, and having a contact that is bent to protrude toward the conductive surface, and a pair of through holes provided at side faces of the cut-and-raised section; and

a substrate inserted into the pair of through holes, and with which the contact is in elastic and electric contact.

(2) The electronic unit according to (1), wherein the cut-and-raised section substantially has a shape of a letter M, and includes a central part serving as the contact.

(3) The electronic unit according to (1), wherein the cut-and-raised section substantially has an arch shape, and includes a central part serving as the contact.

(4) The electronic unit according to (1), wherein the cut-and-raised section substantially has a shape of trapezoid, and upper base of the trapezoid serves as the contact.

(5) The electronic unit according to any one of (1) to (4), wherein the cut-and-raised section has a cantilever structure with a break part.

(6) The electronic unit according to any one of (1) to (5), further including a display panel provided near the conductive surface of the support member.

The disclosure contains subject matter related to that disclosed in Japanese Priority Patent Application JP 2011-196402 filed in the Japan Patent Office on Sep. 8, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An electronic unit, comprising:
a plate-shaped support member having an insulating surface and a conductive surface that are opposed to each other;
a cut-and-raised section provided in the support member, and having a contact that is bent to protrude toward the conductive surface, and a pair of through holes provided at side faces of the cut-and-raised section; and
a substrate inserted into the pair of through holes, and with which the contact is in elastic and electric contact.

2. The electronic unit according to claim 1, wherein the cut-and-raised section substantially has a shape of a letter M, and includes a central part serving as the contact.

3. The electronic unit according to claim 1, wherein the cut-and-raised section substantially has an arch shape, and includes a central part serving as the contact.

4. The electronic unit according to claim 1, wherein the cut-and-raised section substantially has a shape of trapezoid, and upper base of the trapezoid serves as the contact.

5. The electronic unit according to claim 1, wherein the cut-and-raised section has a cantilever structure with a break part.

6. The electronic unit according to claim 1, further comprising a display panel provided near the conductive surface of the support member.
